(19) United States
(12) Patent Application Publication
(10) Pub. No.: US 2007/0089367 A1
(43) Pub. Date: Apr. 26, 2007

(54) Multi pass gasifier

(76) Inventor: Edward Pascal Goddard, Castle Dale, UT (US)

Correspondence Address: Edward P. Goddard, P.O. Box 613, Castle Dale, UT, 84513, US

(21) Appl. No.: 11/320,393

(22) Filed: Oct. 26, 2005

(51) Int. Cl. H01M 8/06

(52) U.S. Cl. 48/61

(57) ABSTRACT

Apparatus and method for high temperature, auto thermal gasification of solid material are disclosed. Resulting in a clean burning uniform gas usually referred to as Producer Gas. The apparatus is comprised of an outer chamber encircling a multi fold gas-path chamber that is suspended. The center of said chamber also serves as a continuous feed stock inlet. Combustion oxidizer is introduced to the lower portion of said chamber through a nozzle, just below a fire grate or screen, producing a high velocity oxidizer flow resulting in a high temperature localized heat zone. Flow is vertical through the combustion zone and into the descending feed stock, resulting in a counter-current flow. Gases and volatized tar and oil flow vertically in the space between the labyrinth and shell where said gas flow velocity is reduced considerably. Some tar and oil condensing takes place and said tar and oil flows downwardly to the heat zone to be further cracked. Said velocity reduction also inhibits particulate flow in said gas stream. Said gases enter the labyrinth as a reduced gas flow where further condensing of remaining tar and oil also takes place in the labyrinth where they will flow downwardly to the concentrated heat zone, resulting in a distilling, reducing, reacting environment. This process is repeated through the several labyrinth passes that produce the conditions and time necessary for complete cracking of the hydrocarbon compounds to a stable gas eliminating the need for tar removal equipment and or scrubbers. This utilizes more of the total B.T.U. available in the solid fuel. Evolved gases are eventually drawn off as a very uniform clean burning synthesis gas, filtered for particulates and fed directly to an internal combustion engine. Below the gasification chamber is an ash collection region, which allows for collection and removal of ash produced in the gasification process

### BACKGROUND OF THE INVENTION

This invention relates to the conversion of hydrocarbon based organic solids. The conversion is derived by high temperature gasification into uniform clean burning gaseous fuel usually referred to as producer gas. Gasification is an old technology with many variations being applied. The process involves a complex combination of pyrolysis and oxidation reactions. Under typical gasification reactions, oxygen levels in the reactor are generally held to less than 30 percent for complete combustion. CO sub 2, CO and hydrogen are the major products. The resultant heat from this combustion causes much of the solid fuel to move through a liquid phase and then to vapor phase leaving only inert materials and ash. The end product of gasification has always been plagued with condensables in the final uses or applications. These condensables are usually referred to as tars in the general sense. Tars are generally placed into three categories: Primary, Secondary, and Tertiary. These tars, and or, lack of tars can be used as indicators of reactor design and performance.

The end use of producer gas has historically been used in boilers, both internal and external combustion boilers, internal combustion engines, and external combustion engines and as town gas. The transfer lines, inlet devices, coolers and associated equipment were always subject to plugging with condensables. To deal with these condensables, removal was the only practical option. This added to the difficulty and expense of any operation, especially in today's world of environmental and health concerns. These waste products are difficult and expensive to dispose of in an environmentally acceptable manner. Gasification processes generally fall into three classifications. 1. Up draft, 2. Down draft, and 3. Cross draft. In each classification of gasifier, a column of solid fuel is introduced through a feed system to the combustion and gasification zone. Through the combustion and gasification and descending feed stock an oxidizer is introduced. The direction of the oxidizer and gas flow relative to the direction of fuel movement determines the class of gasifier. When the oxidizer and resultant gases travel in the same direction as the descending fuel, it is considered a down draft gasifier. When the oxidizer and resultant gases travel opposite that of the descending fuel, it is considered an up draft gasifier. When the oxidizer and resultant gases traverse the descending fuel column, it is considered a cross draft gasifier. Each classification has advantages and disadvantages yet they are all plagued by entrained condensables.

For over 150 years the gasification processes have been limited to fixed bed gasifiers and modified fixed bed gasifiers. The resultant gases had entrained particulates and condensable tars and oils. The entrained matter needed to be filtered out and was discarded or saved to be used in another process. The present invention utilizes a multi pass labyrinth within a combustion, gasification reactor producing a thermal chemical process of reaction, distilling and thermal cracking of entrained tars and oils within the labyrinth. The resultant gases are clean, stable and require very little filtering for particulates.

### OBJECTS OF THE INVENTION

The first object of the present invention relates to a novel approach of using the successful parameters of gasification in producing a “Tar Free” clean burning gas commonly referred to as “Producer Gas”. Another object is to have the reactor as simple as possible, and as a result has no moving parts in the reactor proper. Another object of the invention is to provide a gassifing apparatus that will accommodate a wide variety of carbons based organic fuels and also be moisture tolerant to a point. Another object is to eliminate the necessity of gas cleaning and or scrubbing. A still further object is to utilize the energy that would normally be lost with the tars.

### SUMMARY OF THE INVENTION

The present invention is a gasification apparatus of multi path, labyrinth configuration in which high temperature gasification is carried out by pulling a pulsating oxidizer through a nozzle just below the fire grate. This produces a high velocity stream vertically well into the several stratified zones within the reactor. The fuel feed tube and attached labyrinth encase much of the localized pyrolysis, favoring CO sub 2 and stable gaseous hydrocarbon compounds. It also favors the production of primary tars over secondary or tertiary tars. The gas stream must reverse flow around the ascending oxidizer flow to the outer portions of the feed tube causing a rotating mass of ascending-descending gases, tars and oxidizers. This combustion and gasification environment is of high temperature and time duration to enact an intense pyrolytic environment favoring stable gas production and the destruction of tars.

The resulting gases then flow through a hot glowing bed of charcoal where the CO sub 2 and water vapor are converted to 2CO and hydrogen. All of the gases must flow vertically between the outer shell and labyrinth where the cross sectional area causes a significant reduction in gas velocity. This reduced flow allows for entrained particulates to drop out of the gas stream. The gases flow upwardly through this annular space where condensation of tars and oils take place at various decreasing temperature zones. The condensed tars and oils flow downwardly until they reach a higher temperature level to enact a further reaction and conversion to a stable hydrocarbon gas. The most tertiary of tars flowing back to the high temperature charcoal bed to be converted to stable hydrocarbon gases. This process continues on through the several gas paths of the labyrinth allowing time and temperature to work on converting all of the remaining tars and oils. Including the most tertiary of tars that will flow down on the inside of the labyrinth to the labyrinth bottom which is heated to a high temperature by being in close proximity to the high temperature combustion zone where said tars will be converted to stable hydrocarbon compounds. The gas is then pulled from the reactor as a very uniform clean producer gas to be used as desired.

If used in an internal combustion engine, the engine produces the pulsating effect within the reactor. If used in another fashion, the suction blower with a well known sinusoidal wave form or air flow interrupter may be used to provide the oscillating impulses to strip boundary layer gases from combustion particles and gasifier surfaces. Said pulses of the oxidizer stream also cause a high oxidizing effect with high temperatures followed by a completely oxidizer deficient high gasification environment, resulting in an efficient production of stable gases free of entrained tars and oils.

### DESCRIPTION OF THE DRAWINGS

FIG. 1 is a cross section view of the complete reactor showing the various components. This view shows the fuel path to the combustion, distillation, and gasification zones, to ash collection. This view also shows the oxidizer input, the product gas paths, condensing, and cracking zones through the labyrinth, and to the final outlet of producer gas.

FIG. 2 is a top view of the reactor showing the configuration of the labyrinth within the reactor.

FIG. 3 is a front view of the ash hopper showing the hopper door positioning and to further show the oxidizer supply orientation.

### DETAILED DESCRIPTION

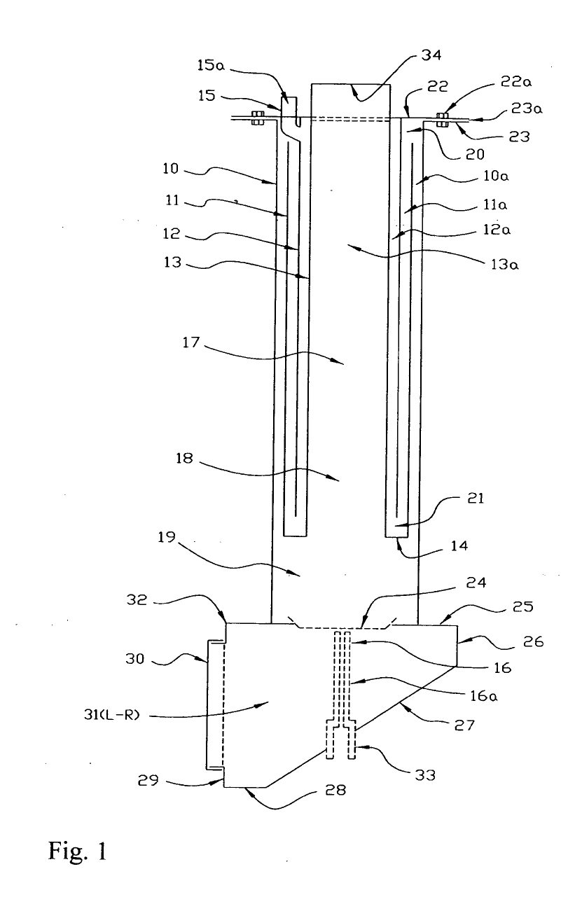

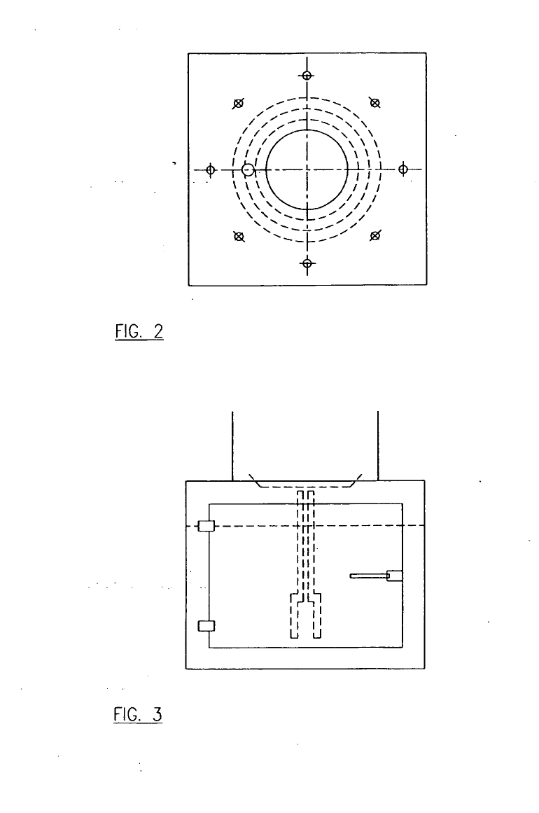

Referring now in detail to a preferred embodiment of the present invention. This is illustrated in the following figures, FIG. 1, FIG. 2, and FIG. 3. Numeral 10 in FIG. 1 denotes the outer shell or main embodiment of the reactor. The outer shell may be made from various types of metal, however due to the high temperatures and harsh environment the preferred metal should be of a high nickel alloy. Outer shell 10 is set above numeral 32, the ash collection assembly and is attached by one of the various means of metal fabrication to enact a gas tight seal. The top of the outer shell 10 has a flange, item 23, attached by one of the various means of metal fabrication to enact a gas tight seal to the top of said outer shell. Item 22 of the labyrinth assembly will provide a sealing area, by a gasket, item 23a and is bolted about its circumference to said plate, item 23. The labyrinth assembly will contain at least two gas passes, but is not limited to only two. The labyrinth assembly comprises of items 11, 12, 13, 14, 15, and 22. The labyrinth assembly parts may be made of various metals but due to the high temperatures and harsh environment, the preferred metals should be of a high nickel alloy. Annular spacing within the labyrinth is comprised of 10a, 11a, 12a, 20 and 21. The annular spacing is of necessary size so as to slow the gas velocity to achieve the necessary dwell time for the reaction process. Also the slowing of the gases allows any entrained particulates to drop out of the gas flow. Item 13 attached by any of the various metal fabrication means to enact a gas tight seal to item 22. Item 13 also protrudes above item 22; to which is attached a sealable feed system such as a rotary valve or star feeder, but is not limited to these designs. Other types of sealing systems may be employed, even a sealable lid through which item 13 may be batch fed. At the bottom of item 13 is a steel plate ring, item 14 which is attached by one of the various metal fabrication means to the inner edge of said plate. The outer edge of item 14 is also attached by one of the metal fabrication means to item 11 which extends vertically but does not extend completely to the top to item 22 allowing an adequate space, numeral 20, for the purpose of providing a slow gas path. Item 12 is attached by one of the metal fabrication means to item 22 and descends between item 13 and item 11 with the necessary spacing to maintain the slow gas path. Item 12 extends from item 22 downwardly and near to item 14. There is a space, number 21, to establish the necessary slow gas path through the high temperature zone on the inside of the labyrinth assembly. This dwell time allows any tars and oils to be cracked to a stable gas. Item 15 is a tube providing an exit path for the gases from the labyrinth gas path, 12a and is attached to item 12 by one of the metal fabrication means to enact a gas tight seal. Item 15 extends up through item 22 and is sealed by one of the metal fabrication means to enact a gas tight seal. Item 25, the reactor bottom plate and ash collection assembly top plate. Located in the center of item 25 is a fire grate or screen, item 24. Ash collection assembly items 26, 27, 28, 29, and 31(L-R) may be fabricated from various types of metal, but a high nickel alloy is not necessary. Typically arranged as a rectangular box of items 26, 29, 31 (L-R) and a sloping floor, items 22 and 28. The ash collection assembly is not limited to this arrangement only. Various other means of ash removal may be applied as long as the reactor maintains an airtight seal to atmosphere. Item 30, a sealable door, which is hinged to provide access for ash removal and initial lighting of the fuel. Item 33 is located centrally with the centerline of the reactor and is attached by one of the metal fabrication means to enact a gas tight seal to item 27. Oxidizer supply nozzle item 16 is attached into item 33 and extends vertically to just below the fire grate item 24.

Now describing in detail the gasification process through the above described gasification reactor. Solid fuel is admitted on an as needed basis through a rotary or star valve of well-known design but is not limited to these designs. A sealable lid may be used and item 13 may be batch fed. Said valve or lid also enacts an airtight seal from atmosphere. Said valve or lid is attached to top of item 13, through which the solid fuel descends through area 13a. Said fuel descends to area 17, which is the distillation zone where initial decomposition of the fuel takes place. Descending to area 18, which is the combustion, gasification zone, a portion of the fuel is combusted with the ascending high velocity impulse oxidizer creating copious amounts of heat to gasify and react with the solid fuel, distilling out the volatiles, tars and oils. An internal combustion engine or suction blower attached to item 15 provides the vacuum through the reactor and up through nozzle 16 creating a high velocity oxidizer stream. The oxidizer impulses are created by the suction impulses of said internal combustion engine or by a suction blower with a well known sinusoidal waveform device or air flow interrupter. This gasification process at this point favors the production of CO sub 2 and H sub 2 O. With the ascending high velocity pulsed oxidizer from nozzle 16, the gaseous environment in areas 17, 18, and 19, form an ascending descending rotating mass, creating the residence time for the hydrocarbon gases to be cracked to stable gases. Said impulses also strip boundary layer gases from combustion particles and reactor surfaces resulting in elevated temperatures and a high oxidizing effect followed by a completely oxidizer deficient high gasification environment. Said gases are eventually drawn downwardly through the carbon bed where the carbon dioxide and H sub 2 O gases are reacted, forming 2CO and Hydrogen. The resultant gases are drawn to the outer area of the reactor and upwardly in the annular space 10a, between the reactor outer shell item 10 and item 11 of the labyrinth assembly. In this annular space, which is of greater cross sectional area, said gases from the gasification process ascend slowly allowing entrained particulates to drop out and fall to the ash area. Said gases, which are stable, continue on through the labyrinth gas paths to the eventual outlet. The tars and oils in gas path 10a ascend vertically to ever decreasing temperature levels within the reactor. Said tars and oils will condense on the reactor wall 10, and on the labyrinth wall, item 11. Said tars and oils will descend downwardly to ever increasing temperature levels. Said tars and oils will arrive to a temperature zone where the heat will crack said tar and oils to stable gases. The most tertiary of tars descending to the high temperature carbon bed to be cracked to a stable gas or burned and add to the heat process of the thermal chemical reaction. Said gases are drawn down through gas pass area 11a where the process of condensation, reacting, and cracking takes place in the descending gas path and increasing temperatures. Any tertiary tars will eventually arrive to area 21 and are deposited on labyrinth plate 14, which is located in the high temperature zone. Any remaining tars and or oils will be cracked to a stable gas. Said gases ascend vertically through area 12a where the Gases must pass, and any remaining condensables will condense on the labyrinth items 12 and 13. Any condensables will flow downwardly in the annular space 12a to be cracked at the appropriate temperature level or on the plate, item 14, on the inside of the labyrinth, located in the high temperature zone. In short, within the reactor are continuous, reacting, cracking, and condensing processes repeated until all that remains is a very stable clean producer gas. Said internal combustion engine or suction blower draws off the resultant gas through gas path 15a and item 15. In the bottom of the reactor all inert material and ash falls through fire grate, item 24, and into ash hopper item 32.

Ash hopper, item 32, comprising of items 25, 26, 27, 28, 29, and 31 (L-R). Item 30, an access door through which the ash is removed, and through which the reactor fire is initiated.

The door is also sealable to enact an airtight seal during the gasification process. Through the bottom of ash hopper item 32 and centrally located with respect to the center line of item 13 of the labyrinth is a fitting, item 33, which is attached by one of the various metal fabrication means to item 27. Item 16 is threaded into item 33, and through this assembly the oxidizer is introduced. Item 16 is also sized to a given relationship with the necessary oxidizer quantity to produce the necessary oxidizer velocity.

The claimed invention is:

1. A gasification apparatus comprising of:
a. A gasification reactor vessel having an outer chamber encircling a multi fold gas path labyrinth.
b. A suspended labyrinth assembly whose central tube serves as a continuous feed stock supply to the combustion zone.
c. In said combustion zone copious amounts of carbon dioxide is formed which will be converted later to 2 CO, which is not typical of an auto thermal gasification process.
d. Gasification zone located below volatilization zone.
e. Carbon bed located below the volatilization zone.
f. Positioning of the labyrinth bottom to be in close proximity to the high temperature combustion zone to enact the CO sub 2 to a 2 CO conversion in the carbon bed located below the concentrated heat zone. Also said conversion to be enacted inside lower portion of labyrinth, which is separated from said heat zone gases by said labyrinth bottom.
g. High velocity, oxidizer inlet nozzle located below gasification zone.
h. Negative pressure, gas suction provided by an internal combustion engine or suction blower.
i. Controlling of oxidizer and fuel feed rate to maintain a concentrated temperature in the combustion zone of 1500 degrees F. to 2100 degrees F. which temperatures are not typical of an auto thermal gasification process.
j. Means of charging feed stock tube and sealing reactor from atmosphere.
k. An ash collection chamber for the ash generated in the process.
l. Output gases are filtered for particulates and fed directly to an internal combustion engine.

2. Apparatus as defined in claim 1 in which the withdrawing of gases through a series of labyrinth passes where said condensable gases will be condensed. Said condensates flow downwardly and are re-introduced in close proximity to, but separated by said labyrinth bottom barrier located near the concentrated heat zone to be further cracked to a stable gas.

3. Apparatus as defined in claim 1 that is H sub 2 O tolerant to the range of 15 percent moisture.

4. Apparatus as defined in claim 1 that is uncharacteristic in that varnish and tars can be reduced.

5. Apparatus that is defined in claim 1 whose labyrinth inhibits particulate flow in gas stream.

6. Carbon bed and combustion zone agitation to eliminate channeling of the oxidizer and bridging of feed stock is achieved by the internal combustion engine vacuum impulses through the reactor.

7. Said impulses, strip boundary layer gases from combustion particles resulting in enhanced combustion and elevated temperatures.

8. Said impulses create a high velocity oxidizer through the inlet nozzle.

9. Said impulses create a time interval of high combustion and temp followed by a time interval of oxygen deficient high gasification.
